(19) United States
(12) Patent Application Publication
(10) Pub. No.: US 2018/0121287 A1
(43) Pub. Date: May 3, 2018

(54) INLINE ERROR DETECTION AND CORRECTION TECHNIQUES

(71) Applicant: NVIDIA CORPORATION, Santa Clara, CA (US)

(72) Inventors: Michael Wasserman, Redwood City, CA (US); Manas Mandal, Palo Alto, CA (US); Steven Molnar, Chapel Hill, NC (US); Jay Gupta, Bangalore (IN); James M. Van Dyke, Austin, TX (US); John Welsford Brooks, Santa Clara, CA (US)

(21) Appl. No.: 15/340,919

(22) Filed: Nov. 1, 2016

(51) Int. Cl. G06F 11/10; G06F 3/06; G06F 12/06

(52) U.S. Cl. CPC G06F 11/1076; G06F 3/0619; G06F 3/064; G06F 2212/403; G06F 3/0673; G06F 12/0646; G06F 2212/1032; G06F 3/0659

(57) ABSTRACT

In accordance with embodiments of the present technology, region based selective error detection and correction techniques provide for the tradeoff between the safety of error detection and error correction (EDEC) protection, and the higher bandwidth and capacity of non-EDEC protection for different uses.

### BACKGROUND OF THE INVENTION

Random access memory is typically used for fast access to instructions and data. However, memory such as dynamic random-access memory (DRAM) is susceptible to one-off changes in the state (e.g., soft errors) of memory cells. Therefore, memory error detection and error correction (EDEC) techniques are used to protect against such soft errors. EDEC can also detect hard errors and permanent faults. EDEC is typically used in multi-user servers, maximum-availability systems, some scientific and financial computing applications, deep-space applications (due to increased radiation), and driver assistance applications in vehicles. However, EDEC techniques are not utilized in most other computing systems to keep costs lower. In addition, EDEC techniques reduce performance due to the additional memory needed to store EDEC codes, and the additional time needed to generate the EDEC codes and to detect and correct errors using the EDEC codes.

### SUMMARY OF THE INVENTION

The present technology may best be understood by referring to the following description and accompanying drawings. The description and drawings are used to illustrate embodiments of the present technology, which are directed toward inline error detection and correction (EDEC) techniques.

The inline error detection and correction techniques include one or more EDEC enabled portions and one or more EDEC disabled portions of memory. A control bit, which may be a function of the memory address, may indicate whether EDEC is enabled or disabled for the corresponding portion of memory. Memory allocated for storing the EDEC codes may be allocated in each respective EDEC enabled and EDEC disabled portion, in each of a plurality of sub-portions within each respective EDEC enable and EDEC disabled portion, or in a separate EDEC code portion of the memory. During write operations, EDEC codes may be generated and stored for EDEC enabled portions of the memory. However, the EDEC codes are not generated and stored if the portion of memory is an EDEC disabled portion. During read operations, the EDEC codes may be read from EDEC enabled portions and used to detect and correct errors therein. This technique, referred to herein as region-based selective EDEC check technique, reduces computational workload and memory bus utilization because EDEC codes are not generated and stored for EDEC disabled portions of the memory. Likewise, computational workload and memory bus utilization is reduced because EDEC codes are not read from EDEC disabled portions of the memory.

In another embodiment, memory for storing the EDEC codes may be allocated for the EDEC enabled portions, but not the EDEC disabled portions. The memory allocated for storing the EDEC codes may be allocated in each respective EDEC enabled portion, in each of a plurality of sub-portions within each respective EDEC enable portion, or in a separate EDEC code portion of the memory. During write operations, EDEC codes may be generated and stored for EDEC enabled portions of the memory. However, the EDEC codes are not generated and stored if the portion of memory is an EDEC disabled portion. During read operations, the EDEC codes may be read from EDEC enabled portions and used to detect and correct errors therein. This technique, referred to herein as a region-based selective EDEC mapping technique, reduces computational workload and memory bus utilization because EDEC codes are not generated and stored for EDEC disabled portions of the memory. Likewise, computational workload and memory bus utilization is reduced because EDEC codes are not read from EDEC disabled portions of the memory. The technique permits increased memory space utilization because memory for storing EDEC codes is not allocated for EDEC disabled portions.

In another embodiment, a periodic EDEC technique can be applied to memory including one or more EDEC enable portions and one or more EDEC disabled portions. In particular, each one of a plurality of EDEC enabled portions of the memory is periodically selected for error detection and error correction. Any corrected words or EDEC enabled portions containing the word are then stored back in the memory. The periodic EDEC technique can advantageously be performed during periods of low system utilization, while reducing the chance of multibit errors when data is stored for relatively long periods of times.

This Summary is provided to introduce a selection of concepts in a simplified form that are further described below in the Detailed Description. This Summary is not intended to identify key features or essential features of the claimed subject matter. Nor is this Summary intended to be used to limit the scope of the claimed subject matter.

### BRIEF DESCRIPTION OF THE DRAWINGS

Embodiments of the present technology are illustrated by way of example and not by way of limitation, in the figures of the accompanying drawings.

FIG. 1 shows a flow diagram of a method of writing and reading data to memory, in accordance with one embodiment of the present technology.

FIG. 2 shows a block diagram of a memory subsystem, for implementing embodiments of the present technology.

FIGS. 3A through 3C show a flow diagram of a method of writing and reading data by a memory subsystem, in accordance with another embodiment of the present technology.

FIGS. 4A through 4C show block diagrams of a memory space in accordance with embodiments of the present technology.

FIGS. 5A through 5D show a flow diagram of a method of writing and reading data by a memory subsystem, in accordance with yet another embodiment of the present technology.

FIGS. 6A through 6C show block diagrams of a memory space in accordance with other embodiments of the present technology.

FIG. 7 shows a flow diagram of a method of error detection and error correction by a memory subsystem, in accordance with yet another embodiment of the present technology.

In the accompanying drawings like reference numerals refer to similar elements.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that all of these terms are to be interpreted as referencing physical manipulations and quantities. Unless specifically stated otherwise or as apparent from the following discussion terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. It is also to be understood that the phraseology and terminology used herein is for the purpose of description and should not be regarded as limiting.

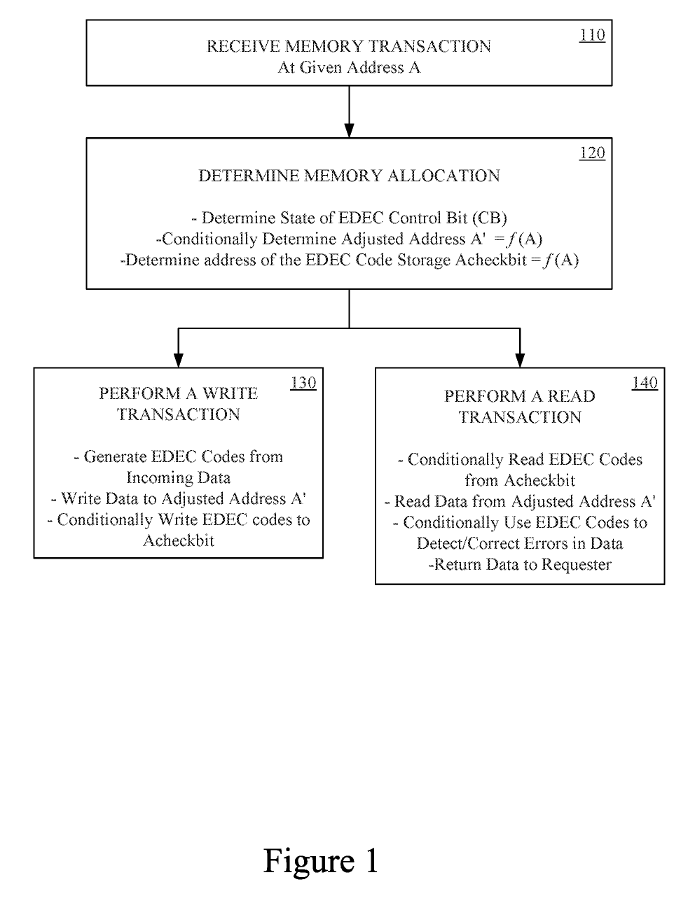

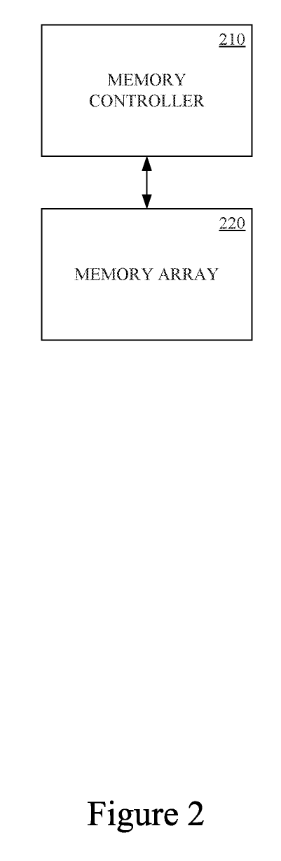

Referring to FIG. 1, a method of writing and reading data to memory, in accordance with one embodiment of the present technology. The method of writing and reading data to memory provides for selective inline error detection and error correction (EDEC). The inline error detection and correction technique will be further explained with reference to FIG. 2, which shows a memory subsystem for implementing embodiments of the present technology.

The method includes receiving a memory transaction, at 110. The memory transaction includes a given address A. The memory transaction may be received by the memory controller 210. The memory transaction may be a read or write to a portion of the memory array 220.

At 120, an allocation of memory is determined. The memory controller 210 determines a state of an EDEC control bit, which is a function of the address A. The EDEC control bit indicates whether EDEC is enabled or disabled. The memory controller 210 also conditionally determines an adjusted address Aadjusted as a function of the given address A. The term adjusted includes an adjustment of zero to the address in applicable cases. The memory controller 210 also determines an address Acheckbit for storing EDEC codes as a function of the given address A.

At 130, a write is performed if the received memory transaction is write transaction. The memory controller 210 generates EDEC codes from the data of the memory transaction, if the EDEC control bit indicates that EDEC is enabled. The memory controller 210 also writes the data to the memory array 220 at the adjusted address Aadjusted, regardless of the state of the EDEC control bit. The memory controller 210 also writes the EDEC codes to the memory array 220 at Acheckbit, if the EDEC control bit indicates that EDEC is enabled.

At 140, a read is performed if the received memory transaction is a read transaction. The memory controller 210 reads the corresponding EDEC codes from the memory array 220 at Acheckbit, if the EDEC control bit indicates that EDEC is enabled. The memory controller 210 also reads data from memory array 220 at Aadjusted, regardless of the state of the EDEC control bit. The memory controller 210 uses the read EDEC codes to detect/correct an errors in the read data, if the EDEC control bit indicates that EDEC is enabled. Thereafter, the memory controller 210 returns the data to the requester.

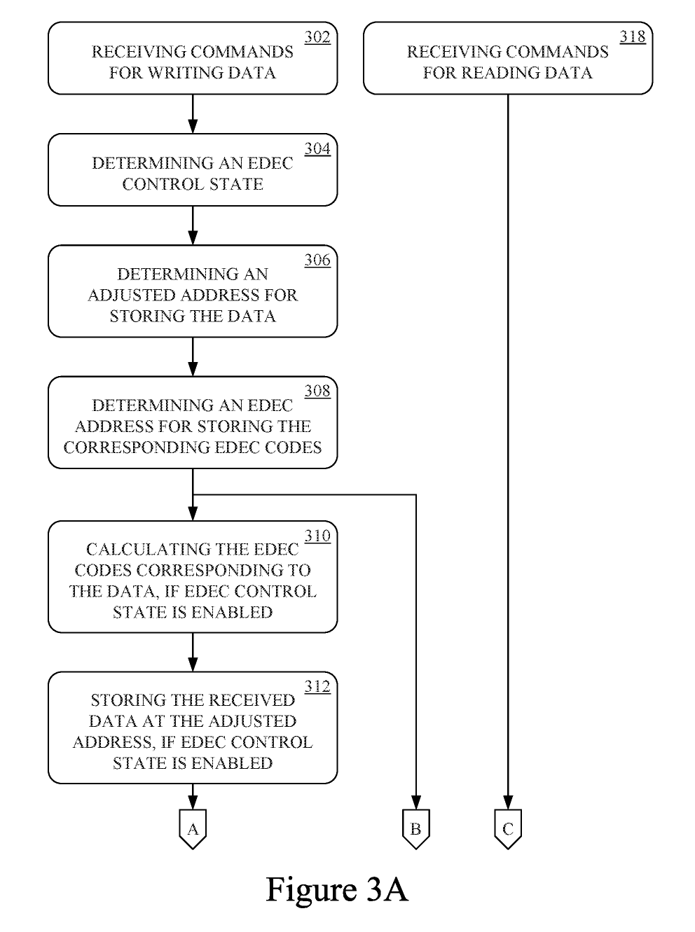

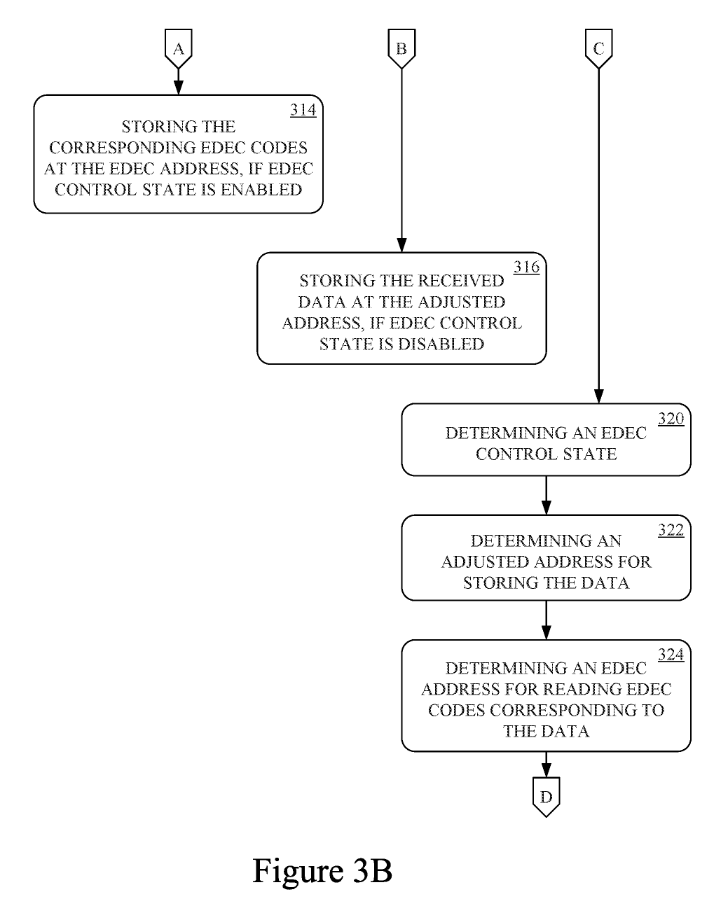

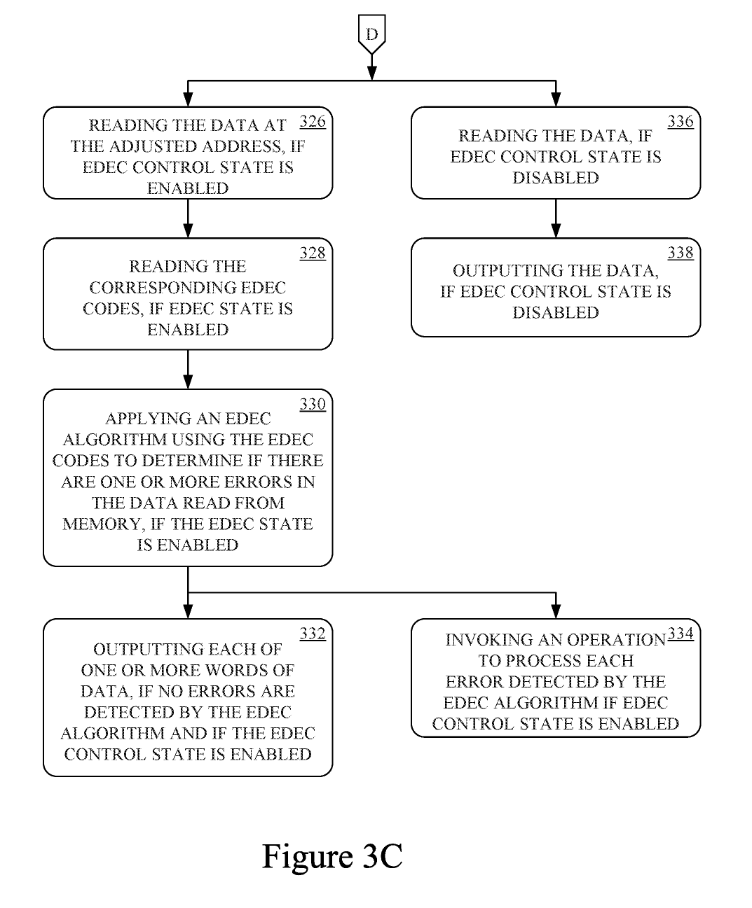

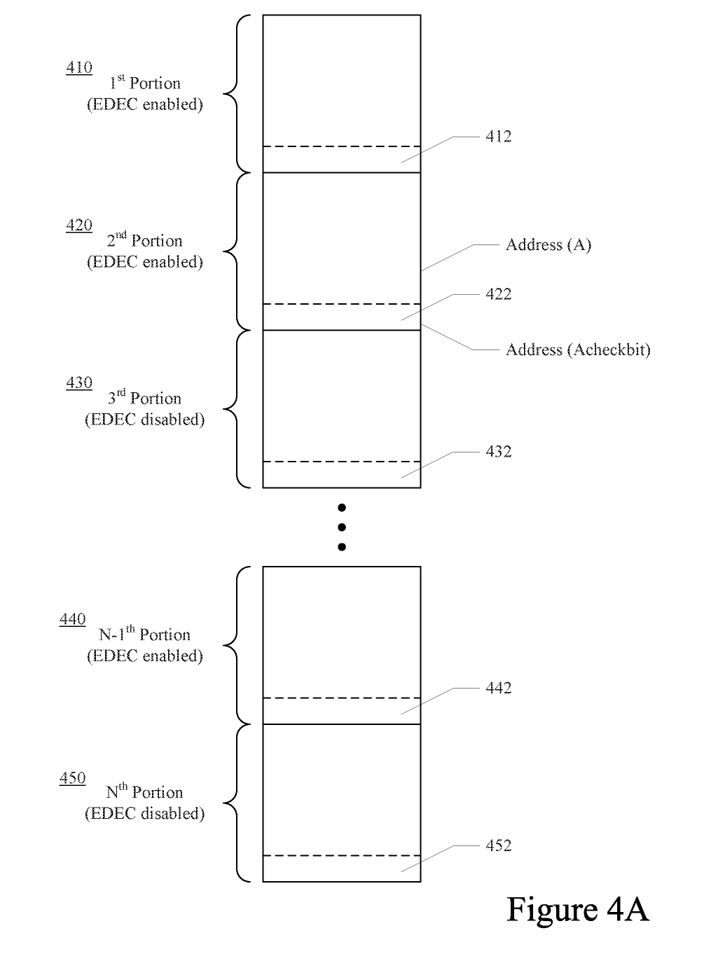

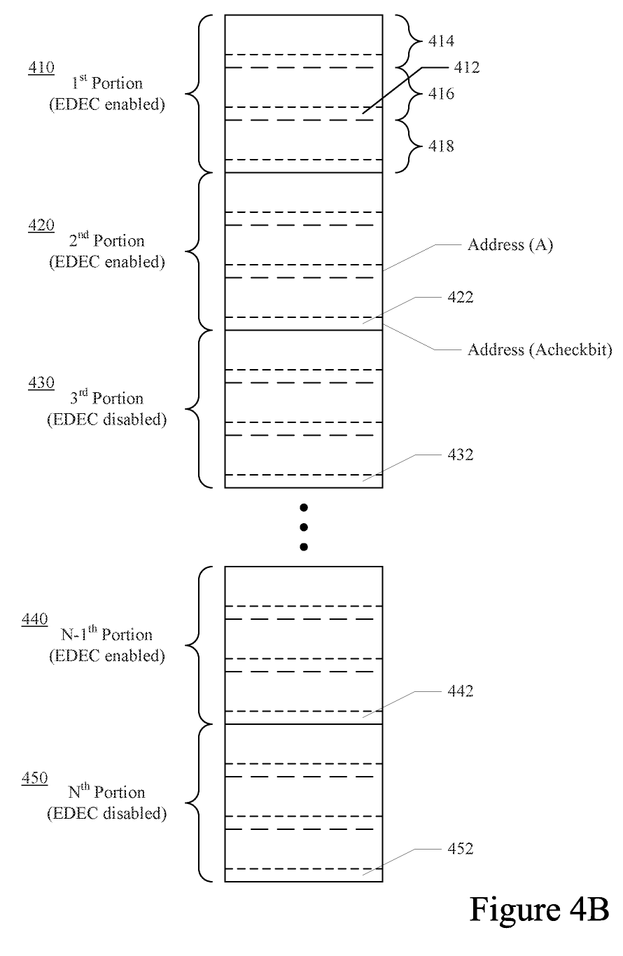

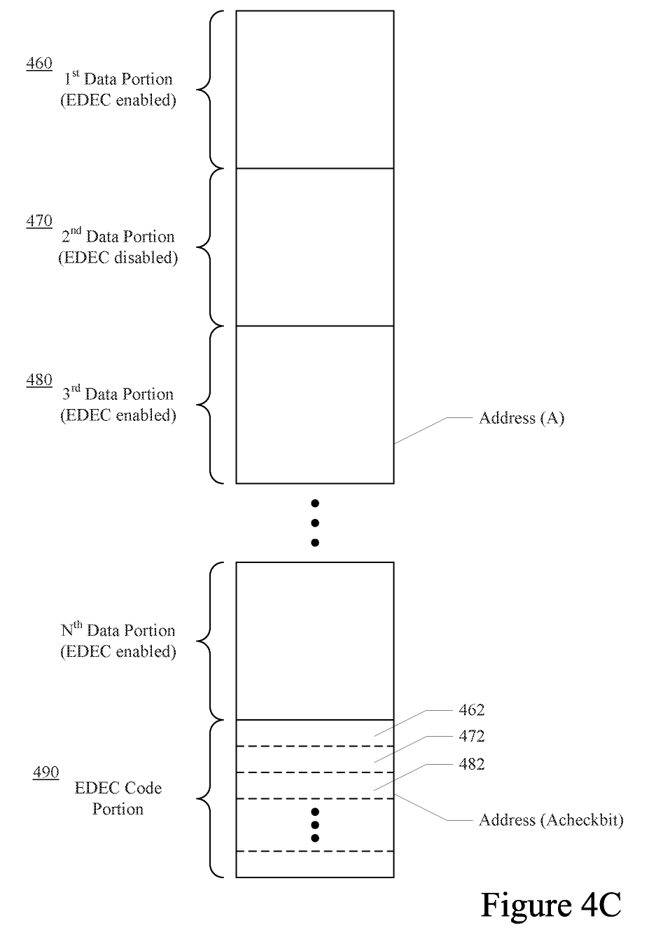

Referring now to FIGS. 3A through 3C, a method of writing and reading data, in accordance with another embodiment of the present technology, is shown. The term data as used herein is intended to include both data and instructions. The method may be implemented in hardware, firmware, as computing device-executable instructions (e.g., computer program) that are stored in computing device-readable media (e.g., computer memory) and executed by a computing device (e.g., processor), or any combination thereof. This method may generally be described as a region-based selective EDEC check technique. The region-based selective EDEC check technique advantageously mitigates the loss of bandwidth due to the EDEC specific processes. The method of writing and reading data will also be described with reference to FIGS. 4A-4C, which illustrate a memory space in accordance with embodiments of the present technology.

The method may begin with receiving commands for writing data at a given address (A), at 302. In one implementation, the commands and data are received by a memory controller from one or more processing units of the computing device. The memory controller may be a separate subsystem of the computing device or integral to one or more others subsystems of the computing device. For example, the memory controller may be implemented as an application specific integrated circuit (ASIC), integral to the random access memory (RAM), or integral to a host interface controller hub.

When the commands for writing data at a given address (A) are received, an EDEC control state is determined, at 304. In one implementation, the EDEC control state is determined as a function of the given address (A). The memory controller may for example be configured with one or more memory mapping tables, one of which may map each of a plurality of regions of the memory space to one or more EDEC protected regions and one or more non-EDEC protected regions.

When the commands for writing the data are received, an adjusted address (Aadjusted) for storing the data is determined based upon the given address, at 306. The adjusted address may be determined by multiplying the given address by a scaling factor based on the ratio of EDEC code to the data generated by the EDEC algorithm. In an exemplary implementation, the write transaction may involve 1K words, 4K words or the like, and the EDEC algorithm generates 1 word of EDEC code for every eight words of data. In such an exemplary implementation, the given address is scaled by 8/7. It is to be appreciated that adjusting the address may be performed by the memory controller substantially in parallel with, or sequentially following, the process of determining the EDEC control state.

At 308, an address (Acheckbit) for storing the EDEC code is determined as a function of the given address (A). In one implementation, a memory mapping table may map the region containing the given address to a corresponding portion of the memory space for storing the corresponding EDEC codes. In one implementation, the address (Acheckbit) for storing the EDEC code is located in a section 412 within the same region 410 as the adjusted address (Aadjusted) for storing the data, as illustrated by FIG. 4A. In another implementation, the address for storing the EDEC code is interleaved within the same sub-region of memory space as the adjusted address (Aadjusted), as illustrated by FIG. 4B. In such an implementation, each region 410 includes a plurality of sub-regions 414, 416, 418. A region may for example be 4 megabytes (MB), and each sub-region may be a 4 kilobyte (kB) page. For each sub-region 414, 416, 418 of data, the corresponding EDEC codes are stored following the data, so that the data and corresponding EDEC codes in a sub-region are interleaved within the region. In yet another implementation, the address (Acheckbit) is located in a predetermined EDEC code region 490, as illustrated in FIG. 4C. In such an implementation, each of a plurality of sections 462, 472, 482 of the EDEC code region 490 correspond to a respective data region 460, 470, 480. It is to be appreciated that even if a given region of the memory space is not EDEC enabled 430, 470, a section 432 within the given region 430, or a corresponding section 472 within a dedicated EDEC code region 490, is allocated for storing EDEC codes.

If the EDEC control state is determined to be enabled, EDEC codes are calculated, at 310. The EDEC algorithm may be any suitable hashing function, such as a single-error correction and double-error detection (SECDED) Hamming code. In an exemplary implementation, the EDEC algorithm may use an 8-bit EDEC code to detect and correct errors of a single bit per 64-bit word, and detect errors of two bits per 64-bit word.

In one implementation, the corresponding EDEC codes may be cached to service one or more other read operations. The cache may store a corresponding EDEC code section 412, or one or more sections 482 of the corresponding EDEC code portion 490. If the EDEC codes are cached, one or more cache management policies may be applied to manage the cached EDEC codes. The memory bus utilization, therefore, can be reduced by utilizing the EDEC codes cached on the memory controller chip.

At 312, the received data is stored in the memory at the adjusted address (Aadjusted), if the EDEC state is enabled. It is to be appreciated that the data may be stored in the memory substantially in parallel with, or sequentially following, the process of calculating the corresponding EDEC codes. At 314, the corresponding EDEC codes are stored in the memory at the EDEC address (Acheckbit), if the EDEC state is enabled. In one implementation, the received data is stored at the adjusted address (Aadjusted) in a given data region 420, and the corresponding EDEC codes are stored at the EDEC address (Acheckbit) in the EDEC code section 422 within the same given data region 420, as illustrated in FIG. 4A. In another implementation, the received data is stored at the adjusted address (Aadjusted) in a given data sub-region 416, and the corresponding EDEC codes are stored at the EDEC address (Acheckbit) in a corresponding section 412 within the same given data sub-region 416, as illustrated in FIG. 4B. In yet another implementation, the received data is stored at the adjusted address (Aadjusted) in a given data region 470, and the corresponding EDEC codes are stored at the EDEC address (Acheckbit) in a corresponding section 472 in a dedicated EDEC code region 490, as illustrated in FIG. 4C. In one implementation the corresponding EDEC codes are stored substantially contemporaneously with storing the received data. In another implementation, the EDEC codes are cached and thereafter stored in memory during periods of low memory controller utilization.

If the EDEC state is disabled, the one or more words of received data are simply stored in the memory at the adjusted address (Aadjusted), at 316.

It is to be appreciated that the processes of adjusting the address and determining an EDEC address, at 306 and 308, are performed regardless of whether the EDEC control state is enabled or disabled. In addition, it's to be appreciated that corresponding EDEC code sections are allocated for both EDEC enabled regions and EDEC disable regions. Therefore, the method is characterized by reduced memory space utilization because EDEC code sections are allocated even for EDEC disabled regions. However, calculating the EDEC code and storing the EDEC code, at 310 and 314, are selective performed when the EDEC control state is enabled. Therefore, the method is characterized by reduced computational workload and reduce memory bus utilization because EDEC codes are not calculated and stored when data is written to EDEC disabled regions of the memory space.

The method also includes receiving commands for reading data at a given address (A), at 318. When commands for reading data at a given address (A) are received, an EDEC control state is determined, at 320. In one implementation, the EDEC control state is determined as a function of the given address (A). The memory controller may for example be configured with one or more memory mapping tables, one of which may map each of a plurality of portions of the memory space to one or more EDEC protected regions and one or more non-EDEC protected regions.

When commands for reading the data are received, an adjusted address (Aadjusted) for retrieving the data is determined based upon the given address, at 322. The adjusted address may be determined by multiply the given address by a scaling factor based on the ratio of EDEC code to the data generated by the EDEC algorithm. In an exemplary implementation, the write transaction may involve 1K words, 4K words or the like, and the EDEC algorithm generates 1 word of EDEC code for every eight words of data. In such an exemplary implementation, the given address is scaled by 8/7. It is to be appreciated that adjusting the address may be performed by the memory controller substantially in parallel with, or sequentially following, the process of determining the EDEC control state.

At 324, the address (Acheckbit) that stores the corresponding EDEC code is determined as a function of the given address (A). In one implementation, a memory mapping may map the region containing the given address to a corresponding section of the memory space for storing the corresponding EDEC codes. Again, the address for storing the EDEC code (Acheckbit), in one implementation, is located in a section 412 in the same data region 410 as the address (A) for storing the data, as illustrated by FIG. 4A. In another implementation, the address for storing the EDEC code is interleaved within the same sub-region of memory space as the adjusted address (Aadjusted), as illustrated by FIG. 4B. In such an implementation, each region 410 includes a plurality of sub-regions 414, 416, 418. A region may for example be 4 megabytes (MB), and each sub-region may be a 4 kilobyte (kB) page. For each sub-region 414, 416, 418 of data, the corresponding EDEC codes are stored following data, so that the data and corresponding EDEC codes in a sub-region are interleaved within the region. In yet another implementation, the EDEC address (Acheckbit) is in a predetermined EDEC code region 490, as illustrated by FIG. 4C. In such an implementation, each of a plurality of sections 462, 472, 482 of the EDEC code region 490 corresponds to a respective data region 460, 470, 480. It is to be appreciated that even if a given region of the memory space is not EDEC enabled 430, 470, a section 432 within the given region 430, or a corresponding section 472 in a dedicated EDEC code region 490, is allocated for storing EDEC codes.

If the EDEC control state is enabled, the data is read from the memory at the adjusted address (Aadjusted), at 326. If the EDEC control state is enabled, the corresponding EDEC codes are also read from the memory at the EDEC address (Acheckbit), at 328. In one implementation, EDEC codes corresponding to the data are read from the memory. In another implementation, the entire corresponding EDEC section within a region, the entire corresponding EDEC code region, or one or more sections of the corresponding EDEC code region, that includes the EDEC code address (Acheckbit), is read from memory.

In one implementation, the corresponding EDEC codes, corresponding EDEC code region, or one or more section of the corresponding EDEC code region, may be cached by the memory controller to service one or more other read operations. If the EDEC codes are cached, one or more cache management policies are applied to manage the cached EDEC codes. The memory bus utilization, therefore, can be reduced by utilizing the EDEC codes cached on the memory controller chip.

If the EDEC control state is enabled, the corresponding EDEC algorithm is applied to determine if the data contains one or more detectable errors, at 330. For each word of data that does not contain errors, the corresponding word is output, at 332. In one implementation, the one or more words of data are output by the memory controller to an appropriate processing unit or other subsystem of the computing device. If the EDEC control state is enable, each error detected by the EDEC algorithm is corrected, at 334. Each correctable error detected by the EDEC algorithm may be directly corrected and output. However, each detected error causes an exception, interrupt or the like to be generated. The exception, interrupt or the like in turn cause another process or routine which corrects the detected error. For example, correcting each error may involve an interrupt that in turn cause a separate read-modify-write process to be performed to correct any correctable error that was detected. In addition or in the alternative, detected errors may also be counted, logged, reported, and/or the like by the memory controller or other subsystems of the computing device. Therefore, correcting errors detected by the EDEC algorithm is broadly defined herein to include processes, routines and the like that directly or indirectly correct, count, log, report and or the like detected errors and outputting the data containing detected errors and/or corrected data.

If the EDEC control state is disabled, the data is read from the memory at the address (A), at 336. At 338, the data is then output, if the EDEC control state is disabled. The data may be output by the memory controller to an appropriate processing unit or other subsystem of the computing device.

Again, it is to be appreciated that the process of adjusting the address and determining an EDEC address, at 322 and 324, are performed regardless of whether the state of the EDEC control state is enabled or disabled. In addition, it's to be appreciated that corresponding EDEC code sections are allocated for both EDEC enabled regions and EDEC disable regions. Therefore, the method is characterized by reduced memory space utilization because EDEC code sections are allocated even for EDEC disabled regions. However, reading the EDEC codes and applying the EDEC algorithm, at 328 and 330, are selectively performed when the EDEC control state is enabled. Therefore, the method is further characterized by reduced computational workload and reduced memory bus utilization because ECED codes are not retrieved and processed when data is read from EDEC disabled regions of the memory space.

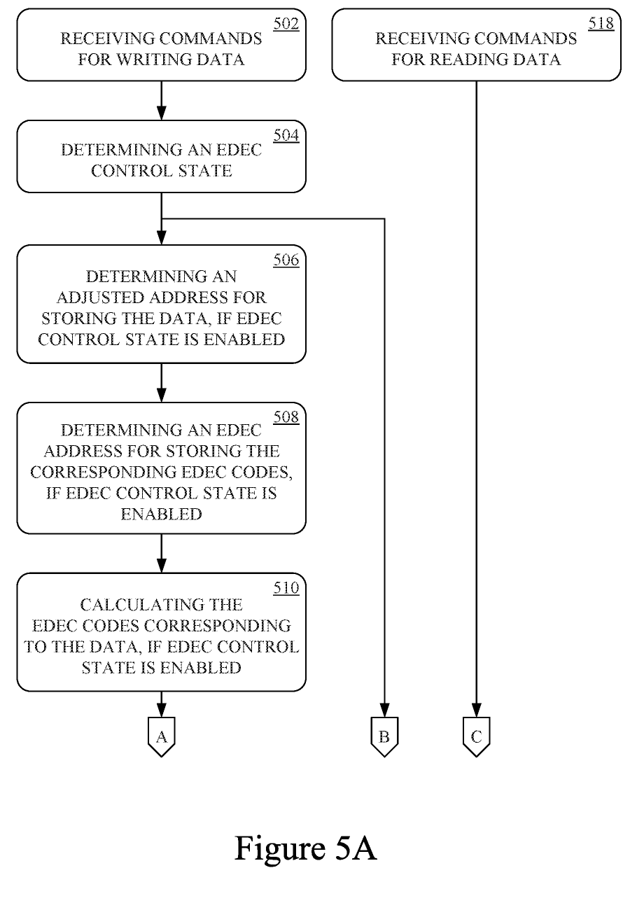

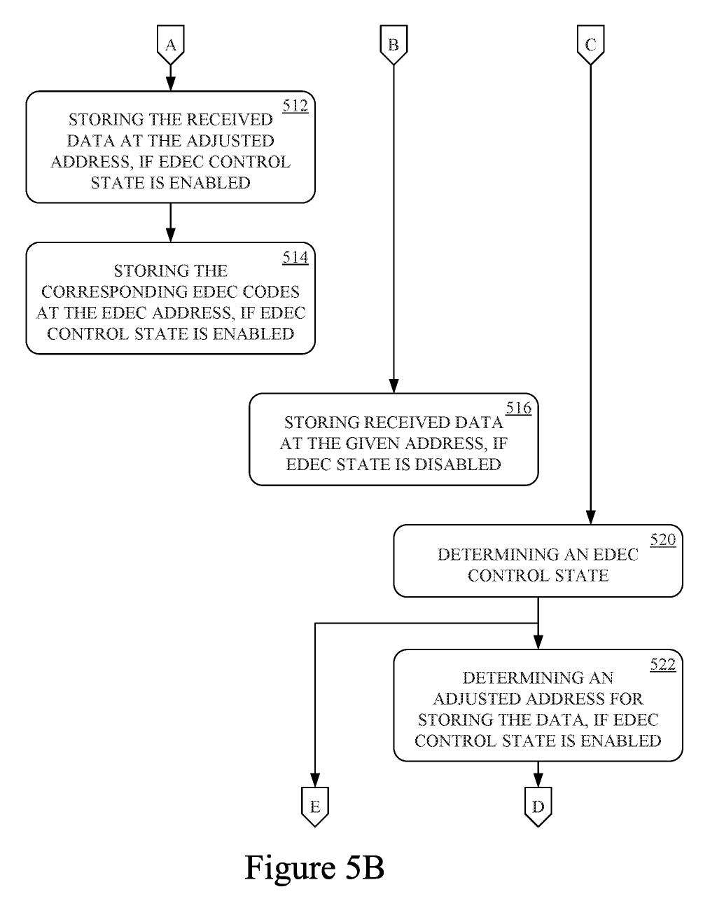

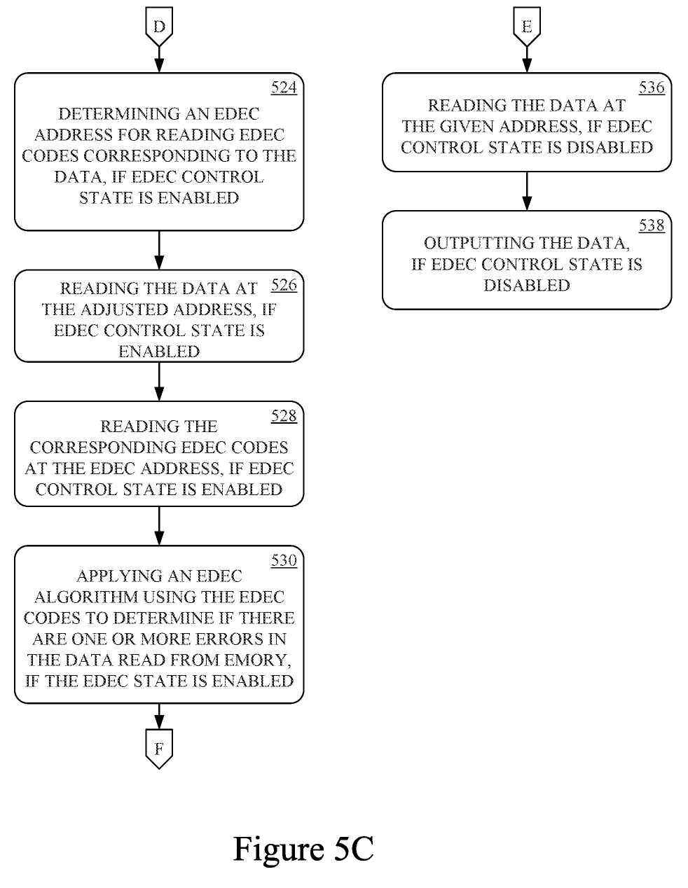

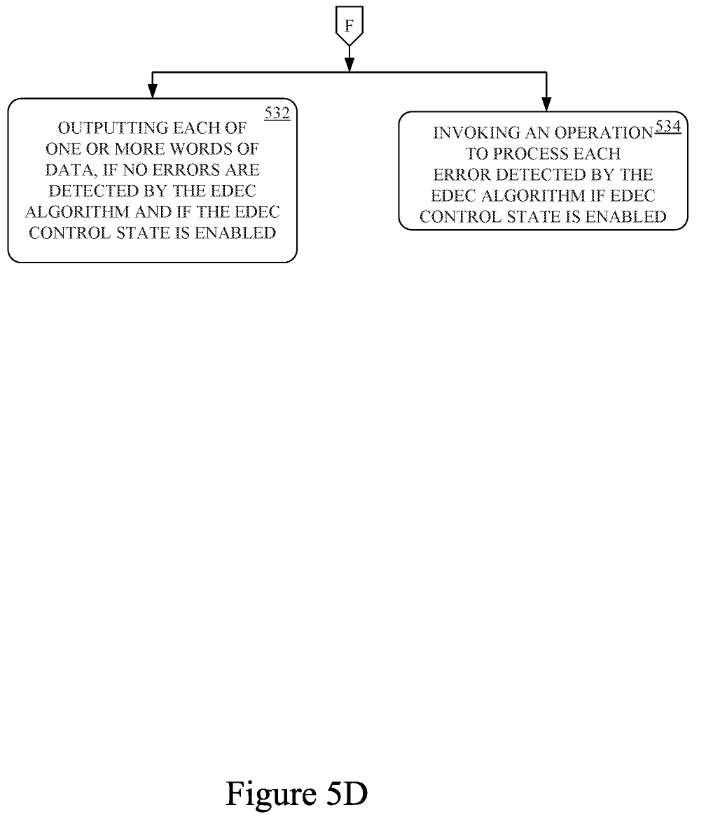

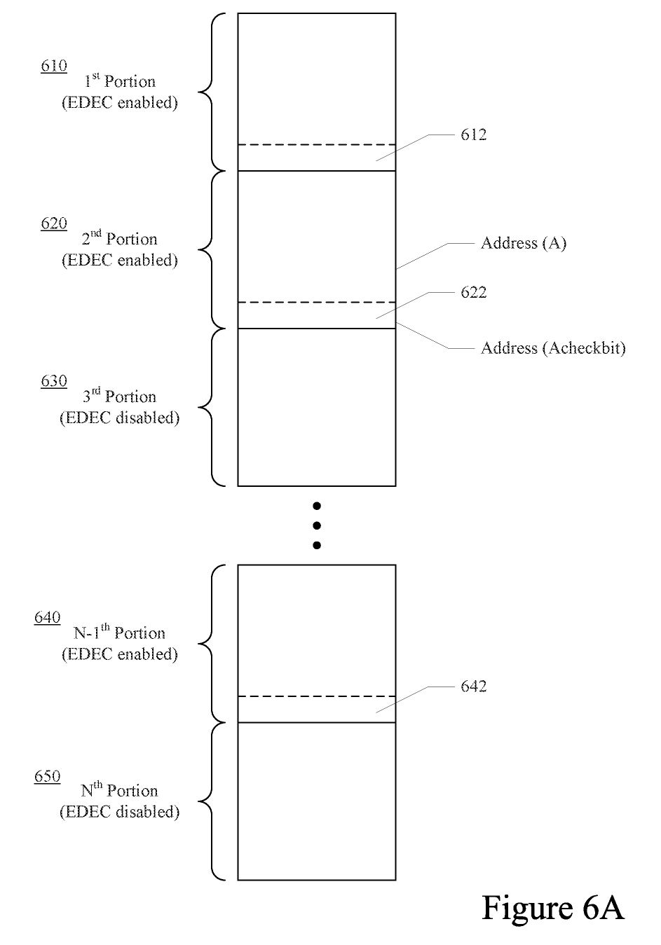

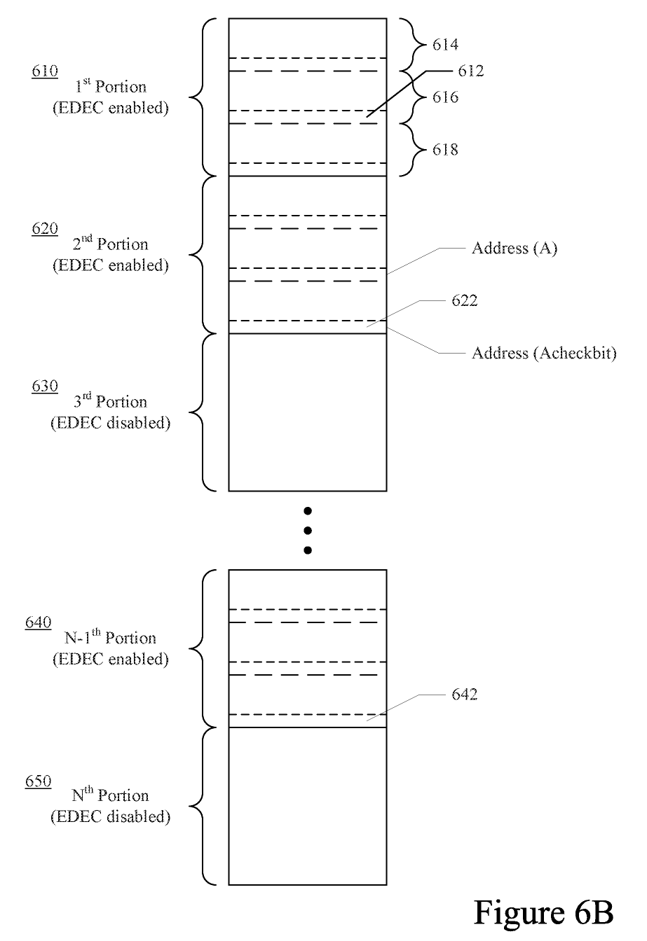

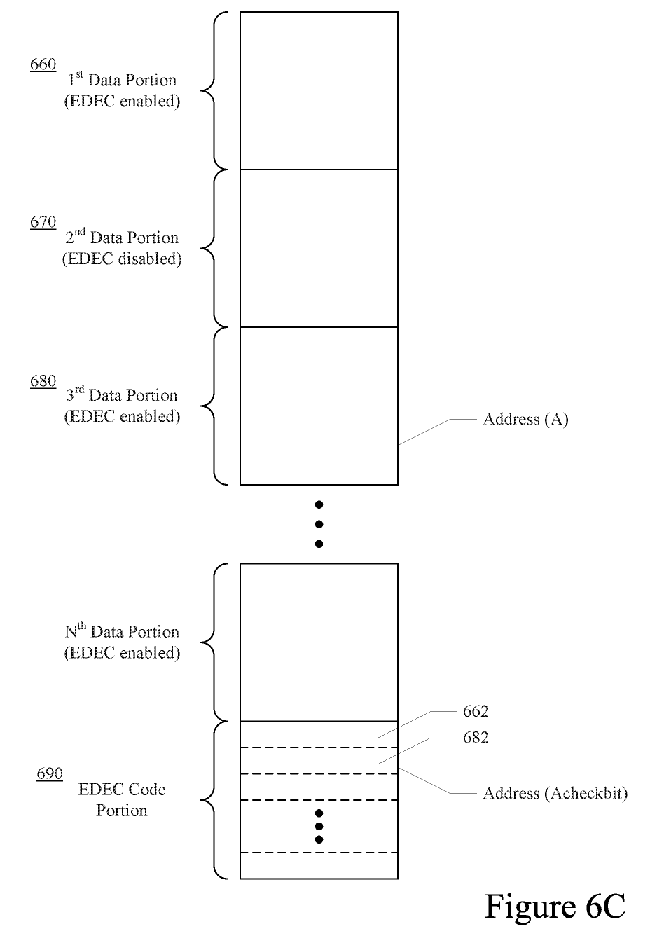

Referring now to FIGS. 5A through 5E, a method of writing and reading data, in accordance with yet another embodiment of the present technology, is shown. This method may generally be described as a region-based selective EDEC mapping technique. The region-based selective EDEC mapping technique advantageously mitigates both the loss of bandwidth and loss of memory storage capacity due to the EDEC specific processes. The method of writing and reading data will also be described with reference to FIGS. 6A and 6B, which illustrate the memory space in accordance with embodiments of the present technology.

The method may begin with receiving commands for writing data at a given address (A), at 502. In one implementation, the commands and data are received by a memory controller from one or more processing units or other subsystem of the computing device. When the commands for writing data at a given address (A) are received, an EDEC control state is determined, at 504. In one implementation, the EDEC control state is determined as a function of the given address (A). The memory controller may for example be configured with one or more memory mapping tables, one of which maps each of a plurality of regions of the memory space to one or more EDEC protected regions and one or more non-EDEC protected regions.

If the EDEC state is determined to be enabled, an adjusted address (Aadjusted) for storing the data is determined based upon the given address, at 506. The adjusted address may be determined by multiplying the given address by a scaling factor based on the ratio of EDEC code to the data generated by the EDEC algorithm. In an exemplary implementation, the write transaction may involve 1K words, 4K words or the like, and the EDEC algorithm generates 1 word of EDEC code for every eight words of data. In such an exemplary implementation, the given address is scaled by 8/7. It is to be appreciated that adjusting the address may be performed by the memory controller substantially in parallel with, or sequentially following, the process of determining the EDEC control state.

At 508, an address (Acheckbit) for storing the EDEC code is determined as a function of the address (A), if the EDEC state is enabled. In one implementation, a memory mapping table may map the region containing the given address (A) to a corresponding portion for storing the corresponding EDEC codes. In one implementation, the EDEC address (Acheckbit) is located in a section 612 within the same region 610 as the address (A) for storing the data, as illustrated by FIG. 6A. In another implementation, the address for storing the EDEC code is interleaved within the same sub-region of memory space as the adjusted address (Aadjusted), as illustrated by FIG. 6B. In such an implementation, each region 610 includes a plurality of sub-regions 614, 616, 618. A region may for example be 4 megabytes (MB), and each sub-region may be a 4 kilobyte (kB) page. For each sub-region 614, 616, 618 of data, the corresponding EDEC codes are stored following the data, so that the data and corresponding EDEC codes in a sub-region are interleaved within the region. In yet another implementation, the EDEC address (Acheckbit) is located in a predetermined EDEC code region 690, as illustrated in FIG. 6C. In such an implementation, each of a plurality of sections 662, 682 of the EDEC code region 690 corresponds to a respective data region 660, 680. However, it is to be appreciated that if a given portion of the memory space is not EDEC enabled there is no corresponding EDEC code section.

If the EDEC control state is determined to be enabled, EDEC codes are calculated, at 510. The EDEC algorithm may be any suitable hashing function, such as a single-error correction and double-error detection (SECDED) Hamming code. In an exemplary implementation, the EDEC algorithm may use an 8-bit EDEC code to detect and correct errors of a single bit per 64-bit word, and detect errors of two bits per 64-bit word.

In one implementation, the corresponding EDEC codes, corresponding EDEC code portion, or one or more sections of the corresponding EDEC code portion may be cached to service one or more other read operations. If the EDEC codes are cached, one or more cache management policies are applied to manage the cached EDEC codes. The memory bus utilization, therefore, can be reduced by utilizing the EDEC codes cached on the memory controller chip.

At 512, the received data is stored in the memory at the adjusted address (A), if the EDEC state is enabled. It is to be appreciated that data may be stored in the memory substantially in parallel with, or sequentially following, the process of calculating the corresponding EDEC codes. At 514, the corresponding EDEC codes are stored in the memory at the EDEC address (Acheckbit), if the EDEC state is enabled. In one implementation, the received data is stored at the adjusted address (Aadjusted) in a given data region 620, and the corresponding EDEC codes are stored at the EDEC address (Acheckbit) in the EDEC code section 622 within the same given data region 620, as illustrated in FIG. 6A. In another implementation, the received data is stored at the adjusted address (Aadjusted) in a given data sub-region 616, and the corresponding EDEC codes are stored at the EDEC address (Acheckbit) in a corresponding section 612 within the same given data sub-region 616, as illustrated in FIG. 6B. In yet another implementation, the received data is stored at the adjusted address (Aadjusted) in a given data region 680, and the corresponding EDEC codes are stored at the EDEC address (Acheckbit) in a corresponding section 682 in a dedicated EDEC code region 690, as illustrated in FIG. 6C. In one implementation the corresponding EDEC codes are stored substantially contemporaneously with storing the received data. In another implementation, the EDEC codes are cached and thereafter stored in memory during periods of low memory controller utilization.

If the EDEC state is disabled, the one or more words of received data are simply stored in the memory at the address (A), at 516.

It is to be appreciated that the process of adjusting the address, determining an EDEC address, calculating the EDEC code, and storing the EDEC code, at 506, 508, 510 and 514, are only performed when the EDEC state is enabled. In addition, it is to be appreciated that, corresponding EDEC code sections are allocated for EDEC enabled regions, but not EDEC disabled regions. Therefore, the method is characterized by increased memory space utilization because EDEC code sections are not allocated when EDEC disabled regions. Therefore, more of the memory space can be utilized to store data. In addition, the method is characterized by reduced computational workload and reduced memory bus utilization because EDEC codes are not calculated and stored when data is written to EDEC disabled regions of the memory space.

The method also includes receiving commands for reading data, at 518. When commands for reading data at a given address (A) are received, an EDEC control state is determined, at 520. In one implementation, the EDEC control state is determined as a function of the given address (A). The memory controller may for example be configured with one or more memory mapping tables, one of which maps each of a plurality of regions of the memory space to one or more EDEC protected regions and one or more non-EDEC protected regions.

If the EDEC control state is enabled, an adjusted address (Aadjusted) for retrieving the data is determined based upon the given address, at 522. The adjusted address may be determined by multiply the given address by a scaling factor based on the ratio of EDEC code to the data generated by the EDEC algorithm. In an exemplary implementation, the write transaction may involve 1K words, 4K words or the like, and the EDEC algorithm generates 1 word of EDEC code for every eight words of data. In such an exemplary implementation, the given address is scaled by 8/7. It is to be appreciated that adjusting the address may be performed by the memory controller substantially in parallel with, or sequentially following, the process of determining the EDEC control state.

At 524, the address (Acheckbit) that stores the corresponding EDEC code is determined as a function of the given address (A), if the EDEC control state is enabled. In one implementation, a memory mapping may map the region containing the given address to a corresponding section of the memory space for storing the corresponding EDEC codes. Again, the address (Acheckbit) for storing the EDEC code, in one implementation, is located in a section 612 within the same region 610 as the address (A) for storing the data, as illustrated by FIG. 6A. In another implementation, the address for storing the EDEC code is interleaved within the same sub-region of memory space as the adjusted address (Aadjusted), as illustrated by FIG. 6B. In such an implementation, each region 610 includes a plurality of sub-regions 614, 616, 618. A region may for example be 4 megabytes (MB), and each sub-region may be a 4 kilobyte (kB) page. For each sub-region 614, 616, 618 of data, the corresponding EDEC codes are stored following data, so that the data and corresponding EDEC codes in a sub-region are interleaved within the region. In another implementation, the EDEC address (Acheckbit) is in a predetermined EDEC code region 690, as illustrated in FIG. 6C. In such an implementation, each of a plurality of sections 662, 682 of the EDEC code region 690 corresponds to a respective data region 660, 680.

If the EDEC control state is enabled, the data is read from the memory at the adjusted address (Aadjusted), at 526. If the EDEC control state is determined to be enabled, the corresponding EDEC codes are also read from the memory at the EDEC address (Acheckbit), at 528. In one implementation, EDEC codes corresponding to the N words of data are read from the memory. In another implementation, the entire corresponding EDEC section within a region, the entire corresponding EDEC code region, or one or more sections of the corresponding EDEC code region, that includes the EDEC code address (Acheckbit), is read from memory.

In one implementation, the corresponding EDEC codes, corresponding EDEC code region, or one or more section of the corresponding EDEC code region, may be cached by the memory controller to service one or more other read operations. If the EDEC codes are cached, one or more cache management policies are applied to manage the cached EDEC codes. The memory bus utilization, therefore, can be reduced by utilizing the EDEC codes cached on the memory controller chip.

If the EDEC control state is enabled, the corresponding EDEC algorithm is applied to determine if the data contains one or more detectable errors, at 530. For each word of data that does not contain errors, the corresponding word is output, at 532. In one implementation, the one or more words of data are output by the memory controller to an appropriate processing unit or other subsystem of the computing device. If the EDEC control state is enable, each error detected by the EDEC algorithm is corrected, at 534. Each correctable error detected by the EDEC algorithm may be directly corrected and output. However, more commonly each detected error causes an exception, interrupt or the like to be generated. The exception, interrupt or the like in turn cause another process or routine which corrects the detected error. For example, correcting each error may involve an interrupt that in turn cause a separate read-modify-write process to be performed to correct any correctable error that was detected. In addition or in the alternative, detected errors may also be counted, logged, reported, and/or the like by the memory controller or other subsystems of the computing device. Therefore, correcting errors detected by the EDEC algorithm is broadly defined herein to include processes, routines and the like that directly or indirectly correct, count, log, report and or the like detected errors and outputting the data containing detected errors and/or corrected data.

If the EDEC control state is disabled, the data is read from the memory at the address (A), at 536. At 538, the words are then output, if the EDEC control state is disabled. The data may be output by the memory controller to an appropriate processing unit or other subsystem of the computing device.

Again, it is to be appreciated that the process of adjusting the address, determining an EDEC address, read the EDEC code, and applying the EDEC algorithm to detect and correct errors, at 522, 524, 528, 530 and 534, are only performed when the EDEC state is enabled. In addition, it is to be appreciated that corresponding EDEC code sections are allocated for EDEC enabled regions, but not EDEC disabled regions. Therefore, the method is characterized by increased memory space utilization because EDEC code sections are not allocated for EDEC disabled regions. Therefore, more of the memory space can be utilized to store data. In addition, the method is characterized by reduced computational workload and reduced memory bus utilization because EDEC codes are not retrieved and processed when data is read from EDEC disabled regions of the memory space.

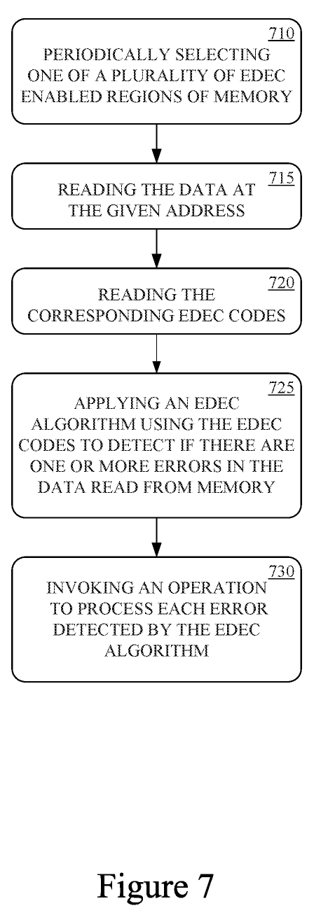

In other embodiments of the present technology, EDEC specific processes may instead be performed periodically, separately from reading data, as illustrated in FIG. 7. Alternatively, the EDEC specific processes may be performed periodically in addition to when reading data from memory.

The method may begin with periodically selecting each of a plurality of EDEC enabled regions of memory, at 710. At 708, an address (Acheckbit) that stores the EDEC code is determined as a function of the given address (A) of the selected EDEC enabled regions. In one implementation, a memory mapping table maps the region containing the given address (A) to a corresponding portion of the memory space for storing the corresponding EDEC codes. Again, the address (Acheckbit) for storing the EDEC code, in one implementation, may be located in a EDEC code section in the same data region that the address for storing the data is located, as illustrated by FIGS. 4A and 6A. In another implementation, the address for storing the EDEC code is interleaved within the same sub-region of memory space as the adjusted address (Aadjusted), as illustrated by FIGS. 4B and 6B. In another implementation, the address (Acheckbit) for storing the EDEC code may be in a predetermined EDEC code region, as illustrated in FIGS. 4C and 6C.

At 715, the data is read from the memory at the adjusted address (Aadjusted) of the selected EDEC enabled region. The corresponding EDEC codes are also read from the memory at the EDEC code address (Acheckbit), at 720. At 725, the corresponding EDEC algorithm is applied to the data and the corresponding EDEC codes read from memory to determine if the data contains one or more detectable errors. For each word of data that contains a correctable bit error, an operation or process may be invoked to correct the error, at 730. In one implementation, each detected error causes an exception, interrupt or the like to be generated. The exception, interrupt or the like in turn cause another process or routine which corrects the detected error. For example, correcting each error may involve an interrupt that in turn cause a separate read-modify-write process to be performed to correct any correctable error that was detected. In addition or in the alternative, detected errors may also be counted, logged, reported, and/or the like by the memory controller or other subsystems of the computing device. Therefore, correcting errors detected by the EDEC algorithm is broadly defined herein to include processes, routines and the like that directly or indirectly correct, count, log, report and or the like detected errors and outputting the data containing detected errors and/or corrected data.

The process of 710-730 is performed for each EDEC enabled region of memory. Furthermore, the process is periodically repeated for each EDEC enable region of memory. In one implementation, the process is periodically repeated based upon the mean time between errors due to common soft error mechanisms. Performing EDEC periodically, instead of in response to a specific read request, may advantageously be utilized when data may be stored in a given location for a relatively long period of time before it is read out again. Furthermore, performing EDEC periodically during low utilization times reduces computational workload and reduced bandwidth utilization, as compared to when performing EDEC during regular read operations.

Embodiments of the present technology advantageously allow EDEC protection to be enabled on a regional basis within a memory. Accordingly, critical data can be placed in EDEC protected regions, while non-critical data may be placed outside of the EDEC protected regions. Therefore, embodiments advantageously allow the tradeoff between the safety of EDEC protection, and the higher bandwidth and memory capacity of non-EDEC protection. For example, the EDEC protected regions may be utilized for driver-assistance and safety-critical application in automotive systems, while the non-EDEC protected regions may be utilized for infotainment systems and the like having a lower standard of safety.

The foregoing descriptions of specific embodiments of the present technology have been presented for purposes of illustration and description. They are not intended to be exhaustive or to limit the invention to the precise forms disclosed. Many modifications and variations are possible in light of the above teaching. The embodiments were chosen and described in order to best explain the principles of the present technology and its practical application. Furthermore, embodiments were chosen and described to enable others skilled in the art to best utilize the present technology and various embodiments. Embodiments were also chosen and described to enable various modifications suited to the particular use contemplated. It is intended that the scope of the invention be defined by the claims appended hereto and their equivalents.

What is claimed is:

1. A method comprising:
receiving a memory transaction with a given address;
determining an EDEC control state;
determining an adjusted address based upon the given address;
determining an EDEC address based upon the given address;
calculating EDEC codes, if the EDEC control state is enabled and the memory transaction is a write;
storing the data in memory at the adjusted address, if the memory transaction is a write; and
storing the EDEC codes in the memory at the EDEC address, if the EDEC control state is enabled and the memory transaction is a write.

2. The method according to claim 1, further comprising:
reading data from the memory at the adjusted address, if the memory transaction is a read;
reading EDEC codes, corresponding to the data, from memory at the EDEC address, if the EDEC control state is enabled and the memory transaction is a read;
applying an EDEC algorithm using the EDEC codes to detect if there are one or more detectable errors in the data read from memory;
outputting the data read from memory, if the EDEC control state is disabled and the memory transaction is a read;
outputting each word of data if no error is detected in the corresponding word and the memory transaction is a read; and
invoking an operation to process each error detected by the EDEC algorithm if the EDEC control state is enabled and the memory transaction is a read.

3. The method according to claim 2, wherein the EDEC control state is determined from the given address.

4. The method according to claim 3, wherein the EDEC control state is determined from a mapping between each of a plurality of regions of a memory space and one or more EDEC protected regions and one or more non-EDEC protected regions.

5. The method according to claim 2, wherein the EDEC address for storing the EDEC code is located in a section within a same region of a memory space as the given address.

6. The method according to claim 5, wherein the EDEC address for storing the EDEC code is further interleaved within a same sub-region of the memory space as the given address.

7. The method according to claim 2, wherein the EDEC address for storing the EDEC code is located in a predetermined EDEC code region, wherein each of a plurality of section of the predetermined EDEC code region corresponds to a respective data region of a memory space.

8. The method according to claim 1, further comprising:
periodically selecting each one of a plurality of EDEC enabled regions of the memory;
reading data from memory at the selected EDEC enabled region;
reading EDEC codes, corresponding to the data of the selected EDEC enabled region, from memory;
applying an EDEC algorithm using the EDEC codes to detect if there are one or more detectable errors in the data read from memory at the selected EDEC enabled region; and
invoking an operation to process each error detected by the EDEC algorithm.

9. A method comprising:
receiving a memory transaction with a given address;
determining an EDEC control state;
determining an adjusted address based upon the given address of the memory transaction, if the EDEC control state is enabled;
determining an EDEC address based upon the given address, if the EDEC control state is enabled;
reading from memory at the adjusted address, if the memory transaction is a read;
reading the EDEC codes, corresponding to the data, from memory at the EDEC address, if the EDEC control state is enabled and the memory transaction is the read;
applying an EDEC algorithm using the EDEC codes to detect if there are one or more detectable errors in the data read from the memory;
outputting the data read from memory, if the EDEC control state is disabled and the memory transaction is the read;
outputting each word of data if no errors are detected in the corresponding word and the memory transaction is the read; and
invoking an operation to process each error detected by the EDEC algorithm if the EDEC control state is enabled and the memory transaction is a read.

10. The method according to claim 9, further comprising:
calculating EDEC codes, if the EDEC control state is enabled and the memory transaction is a write;
storing the data in the memory at the adjusted address, if the memory transaction is the write; and
storing the EDEC codes in the memory at the EDEC address, if the EDEC control state is enabled and the memory transaction is a write.

11. The method according to claim 10, wherein the EDEC control state is determined from the given address.

12. The method according to claim 11, wherein the EDEC control state is determined from a mapping between each of a plurality of regions of a memory space and one or more EDEC protected regions and one or more non-EDEC protected regions.

13. The method according to claim 10, wherein the EDEC address for storing the EDEC code is located in a section within the same region of a memory space as the given address.

14. The method according to claim 13, wherein the EDEC address for storing the EDEC code is further interleaved within a same sub-region of the memory space as the given address.

15. The method according to claim 10, wherein the EDEC address for storing the EDEC code is located in a predetermined EDEC code region, wherein each of a plurality of section of the predetermined EDEC code region corresponds to a respective data region of a memory space.

16. The method according to claim 10, further comprising:
periodically selecting each one of a plurality of EDEC enabled regions of the memory;
reading data from memory at the selected EDEC enabled region;
reading EDEC codes, corresponding to the data of the selected EDEC enabled region, from memory;
applying an EDEC algorithm using the EDEC codes to detect if there are one or more detectable errors in the data read from memory at the selected EDED enabled region;
invoking an operation to process each error detected by the EDEC algorithm.
